(19) United States
(12) Patent Application Publication
(10) Pub. No.: US 2004/0257740 A1
(43) Pub. Date: Dec. 23, 2004

(54) Circuit arrangement, switching module comprising said circuit arrangement and use of switching module

(76) Inventors: Christian Block, Stainz (AT); Holger Fluhr, Graz (AT); Kurt Wiesbauer, Kalsdorf (DE); Johann Riedler, Feldshorder (AT); Heinz Ragossnig, Gross St. Florian (AT); Heinz Florian, Bad Gams (AT); Gunther Greier, Graz-St. Peter (AT)

Correspondence Address: FISH & RICHARDSON PC, 225 FRANKLIN ST, BOSTON, MA, 02110, US

(21) Appl. No.: 10/490,711

(22) PCT Filed: Sep. 27, 2002
(86) PCT No.: PCT/DE02/03665

(30) Foreign Application Priority Data
Sep. 28, 2001 (JP) 101 48 014.8
Jan. 16, 2002 (JP) 102 01 438.8

(51) Int. Cl. H02H 7/20

(52) U.S. Cl. 361/112; 455/83

(57) ABSTRACT

The invention relates to a circuit array with an antenna input (1), a signal input (2) and a signal output (3), and having a switch unit (4) which has a control line (5), with which the optional connecting of the antenna input (1) to the signal input (2) or the signal output (3) can be controlled, in which the antenna input (1) is connected to a first protective device (6) against electrostatic discharges and the control line (5) to a second protective device (7) against electrostatic discharges. As a result of the protective device in the control line, the ESD safety of the circuit array can be improved. The invention also relates to a circuit module and its use as a front-end module in a mobile telephone.

The invention relates to a circuit array, which has an antenna input, a signal input and a signal output. In addition, the circuit array has a switch unit that optionally connects the antenna input with the signal input or the signal output. In addition, the circuit array has a control line.

Circuit arrays of the type mentioned above are often used as multi-band front-end modules for mobile telephones. In this application, they are connected to the antenna of a mobile telephone at the antenna input. When the antenna comes into contact with an electrically-charged user, this can result in electrostatic discharge, also known under the name “electrostatic discharge (ESD).” These electrostatic discharges can create voltage peaks that are capable of destroying the circuit array. Thus, it is necessary to equip circuit arrays of the type mentioned initially with a device that protects against ESD.

Printed specification WO 00/57515 discloses circuit arrays of the type mentioned initially that are equipped with a protective device against ESD. The protective device comprises an electric high-pass filter in which a capacitor is connected in series and an inductor is connected in parallel to the antenna input path.

A drawback of the known circuit array is that the ESD protective device only helps reduce the ESD impulse entering the circuit array directly through the antenna. In addition to the impulse entering the circuit array directly through the antenna, an electrostatic discharge can also generate a high voltage in the circuit array through ground coupling. This can occur, for example, because the control input normally used in a circuit is arranged either on the high voltage (high) or on a low voltage (low). In this case, the high voltage (high) is defined, for example, by the fact that it lies 2.3 V above the ground voltage of the circuit array. Because, in the case of a mobile telephone, as with many other devices based on signal transmission via antennas, the signal input runs from the antenna to the system's ground, an electrostatic discharge can also directly affect the ground voltage of the circuit array in a circuit array of the type mentioned above. As a result of the directly coupling of a control line to ground through the “high” condition, the voltage impulse resulting from an electrostatic discharge can not only affect the path, via the antenna, but also the circuit array, via the control line. The circuit array known in the art is not protected against these effects.

In addition, the high-pass filter used in the known circuit array has the characteristic of being a very simply designed filter that allows all frequency components of a signal, beginning with a certain cutoff frequency, to pass through it virtually unimpeded. In general, however, only a very narrow frequency range is relevant to the further processing of the signal received by the antenna in the mobile telephone. For example, frequencies between 1 and 2 GHz are used in mobile telephones based on the GSM, PCN or PCS standard. All other frequencies received by the antenna tend to be interfering and, therefore, must be filtered out. Accordingly, at least one band-pass filter is needed to make the signal captured by the circuit array mentioned initially capable of being processed for a mobile telephone. The high-pass filter arranged in the known circuit array can only cut off frequencies below a certain cutoff frequency.

For this reason, at least one filter circuit must be connected downstream from this filter in order to remove the frequency range relevant to the mobile telephone from the signals received by the antenna.

Accordingly, an advantage of the known circuit array is that the high-pass filter circuit used to protect against ESD has an insertion loss, causing the wanted signals to undergo a certain attenuation, although cutting of the transmitted frequency band does not take place. Accordingly, a disadvantage of the known circuit array is a generally high insertion loss.

The goal of this invention, therefore, is to provide a circuit array of the type mentioned initially, in which protection against electrostatic discharge is improved.

This goal is achieved through a circuit array according to claim 1. Additional advantageous embodiments of the invention, as well as a circuit module and the use of the circuit module can be seen from the dependent claims.

A circuit array is described which contains a switch unit with an antenna input, a signal input, and a signal output. The switch unit is suitable for electrically connecting the antenna input with either the signal input or the signal output. In addition, a control line that controls the switch position in the switch unit is arranged at the switch unit. Additionally, the antenna input is connected to a first protective device against electrostatic discharges. The control line is also connected to a second protective device against electrostatic discharges.

The protective devices against electrostatic discharges are advantageously connected to a ground connection, into which the excess voltage from the electrostatic discharges can be discharged.

The switch unit can, for example, be a voltage-controlled switch, such as the type normally used in mobile telephone because of its low power consumption. In particular, a gallium-arsenide switch can be used as the switch unit.

The switch unit can also have multiple signal inputs and outputs. Accordingly, multiple control lines are needed.

The gallium-arsenide switch can also be provided with a decoder, which can be used to reduce the number of control lines. Such a decoder normally requires a power supply, which is connected via a supply line. The ESD protection of such a circuit can be improved even further by connecting the supply line to a third protective device against electrostatic discharges.

The decoder can also be designed so that the voltages of the control lines are generated from the voltage of the supply line. This can be accomplished by means of so-called “pull-up resistors,” for example. Then ESD protection can be simplified by providing only the power supply line with a second protective device. In this case, protection of the control lines is provided through the protection of the power supply.

The circuit array can also contain frequency filters that are assigned to individual signal inputs or signal outputs. They are especially suitable for filtering the frequencies received by the antenna on a mobile telephone in such a way that the signals conducted and filtered through the signal output can be processed further by the mobile telephone.

The same applies to the signal inputs of the circuit array, which, in a mobile telephone, are used to transmit the voice signals generated in the mobile telephone to a receiver via the antenna.

The use of a voltage-limiting element, which is connected in parallel to the control line and is also connected to the ground potential, represents another option for a second protective device against electrostatic discharges. Such a voltage-limiting element can be a varistor, for example. Such a varistor has very low resistance beginning at a certain cutoff voltage, so that excess voltage against ground can be diverted. Varistors with low switching voltage are especially suitable, because this minimizes the residual voltage that occurs in a voltage impulse and loads the circuit array. For this reason, it is advisable to use varistors with a varistor voltage of between 4 and 20 V. Accordingly, the terminal voltage in a voltage impulse that loads the circuit array is about 8 to about 50 V. As a result, the circuit array can be reliably protected against destruction in the event of an ESD impulse.

Another possibility is to use a switch spark gap as a second protective device against electrostatic discharges.

A voltage-limiting element can also be used as a first protective device against electrostatic discharges. An electric frequency filter, for example, can be used as a voltage-limiting element. Another option is a varistor or a switch spark gap.

An advantage of the circuit array of the invention is that, as a result of the additional ESD protection in the control line of the switch unit, the protective measure against ESD at the antenna input can be designed in a less complex manner. In the event that the first protective device is an electric filter, for example, it is possible to execute this filter with a small number of components, which, though worsening the filtering characteristics as such, positively influences the insertion loss.

In the event that the circuit array of the invention is designed with a varistor as the first protective device against electrostatic discharges, it is possible to use, on the antenna end, a varistor with a somewhat higher switching voltage and therefore a more cost-effective component. For example, a varistor with a switching voltage of 50 V instead of a switching voltage of 6 V can be used as the first protective device. A switching voltage of 6 V would be necessary to protect the circuit array against ESD impulses in the event that the control line itself does not provide further protection.

In particular, it is advantageous that the varistor have a switching voltage <6 V.

As a result of the invention, the protective device at the antenna input can be executed in the form of an electric frequency filter with an insertion loss less than 0.3 dB.

The invention also specifies a circuit array in which the antenna input is connected to an antenna, and in which the signal output is connected to a receiving amplifier of a mobile telephone and the signal input to a transmission amplifier of a mobile telephone.

In addition, a circuit module is specified which contains a circuit array according to the invention. The circuit module also contains a multilayer ceramic substrate with integrated passive components, which form electric frequency filters. These frequency filters are assigned to the signal inputs and/or outputs. The switch unit, which can, for example, be executed with the aid of PIN diodes or in the form of a gallium-arsenide switch, is arranged on the upper side of the multilayer ceramic substrate. In addition, the first and, if applicable, second protective device against electrostatic discharges is integrated into the circuit module.

An advantage of the circuit module is that, as a result of the integration of the passive components into the ceramic substrate, as well as the integration of the protective device into the circuit module, a high degree of integration is achieved, which advantageously affects the space requirements of the circuit module. The integration of the first and, if applicable, second protective device into the circuit module can occur, for example, by mounting these components onto the surface of the ceramic substrate, adjacent to the switch unit.

In particular, it is also advantageous to use the circuit module as a front-end module in a mobile telephone.

In the following, the invention is explained in greater detail on the basis of example embodiments and the corresponding diagrams.

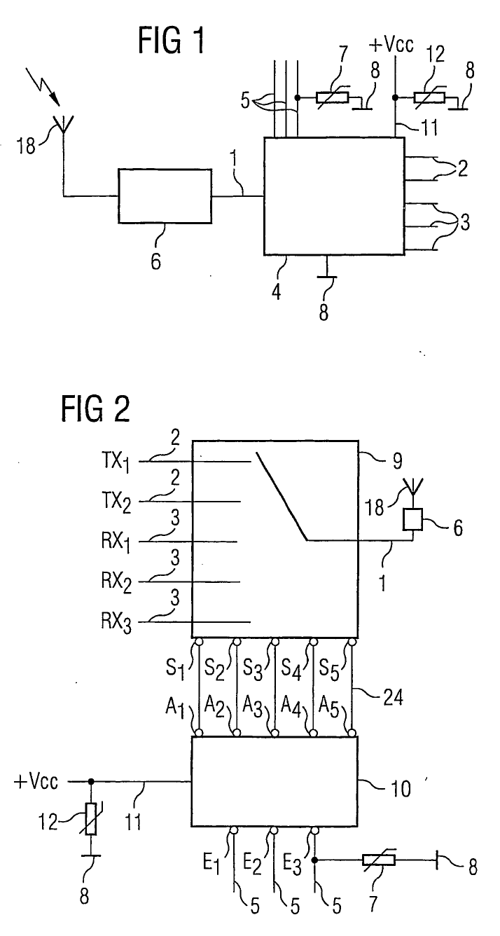

FIG. 1 shows, as an example, a circuit array according to the invention in a basic circuit diagram.

FIG. 2 shows, as an example, another circuit array according to the invention in a basic circuit diagram.

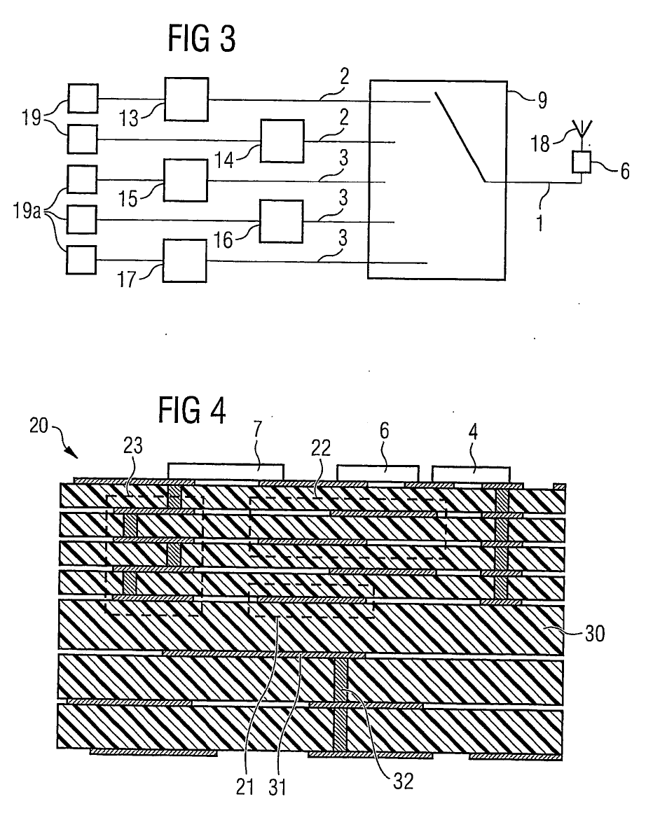

FIG. 3 shows, in a basic circuit diagram, the use of the circuit array according to the invention in a mobile telephone.

FIG. 4 shows, as an example, the circuit module according to the invention in a schematic longitudinal section.

The same reference symbols refer to the same elements in all diagrams.

FIG. 1 shows a circuit array with a switch unit 4, which is provided with a ground 8. The switch unit 4 has an antenna input 1, which is connected to an antenna 18. The antenna input 1 is connected to a first protective device 6 against electrostatic discharges (indicated by the lighting symbol in FIG. 1). The switch unit 4 contains at least one control line 5, which controls the switching process for connecting the antenna input 1 with the signal inputs 2 or the signal outputs 3 of the switch unit 4. Three control lines 5 are shown in FIG. 1. At least one of these control lines is provided with a second protective device 7 against electrostatic discharges. This second protective device 7 can contain, as a voltage-limiting element, a varistor, which is connected to the ground 8. The switch unit 4 depicted in FIG. 1 also has a decoder, for which a supply line 11 is required. The supply line 11 is connected to a supply voltage +Vcc. In addition, the supply line 11 is connected to a third protective device 12 against electrostatic discharges. The third protective device 12 can, for example, be a varistor that is connected to the ground 8.

FIG. 2 shows a voltage-controlled GaAs switch 9 with an antenna input 1, to which the antenna 18 is connected. The GaAs switch 9 has transmitter inputs TX₁ and TX₂, and receiver inputs RX₁, RX₂, and RX₃. The GaAs switch 9 is controlled through control inputs S₁, S₂, S₃, S₄, and S₅. Control takes place in that exactly one of the control inputs S₁, S₂, S₃, S₄, and S₅ is set to “high,” while the remaining control inputs are set to “low.” The number of inputs needed can be reduced using the decoder 10 connected to the GaAs switch 9. The decoder 10 can be a 1-decoder or a 5-decoder, for example. It has control inputs E₁, E₂, and E₃, as well as control outputs A₁, A₂, A₃, A₄, and A₅. The control outputs A₁, A₂, A₃, A₄, and A₅ are connected to the control inputs S₁, S₂, S₃, S₄, and S₅ of the GaAs switch 9 through connection lines 24.

The control inputs E₁, E₂, and E₃ of the decoder 10 are connected to the control lines 5.

An example of the decoding of a logical signal applied to one of the inputs E₁, E₂, and E₃ of the decoder 10 into signals applied to the control inputs S₁, S₂, S₃, S₄, and S₅ of the GaAs switch 9 that are suitable for controlling the GaAs switch is described by the following translation table:

TABLE 1
Logical states of the control inputs S₁, S₂, S₃, S₄, and S₅ as a factor of the
logical states at the control inputs E₁, E₂, and E₃.
1 signifies “high” and 0 signifies “low.”

| E₁ | E₂ | E₃ | → | S₁ | S₂ | S₃ | S₄ | S₅ |
|---|---|---|---|---|---|---|---|---|
| 0 | 0 | 0 | | 1 | 0 | 0 | 0 | 0 |
| 0 | 0 | 1 | | 0 | 1 | 0 | 0 | 0 |
| 0 | 1 | 0 | | 0 | 0 | 1 | 0 | 0 |
| 0 | 1 | 1 | | 0 | 0 | 0 | 1 | 0 |
| 1 | 0 | 0 | | 0 | 0 | 0 | 0 | 1 |

In this case, the transmitter inputs TX₁ and TX₂ correspond to the signal inputs from FIG. 1. The receiver inputs RX₁, RX₂, and RX₃ correspond to the signal outputs 3 from FIG. 1.

FIG. 3 depicts a circuit module with a GaAs switch 9, which has an antenna input 1 as well as two signal inputs 2 and three signal outputs 3. In addition, the circuit module has two low-pass filters 13, 14, wherein the low-pass filter 13 can be configured for the GSM frequency band and the low-pass filter 14 for the PCN/PCS frequency band. The GaAs switch 9 optionally connects one of the inputs/outputs 2, 3 with its antenna input 1. The circuit module also has band-pass filters 15, 16, 17, which are connected to the signal outputs 3. The band-pass filter 15 is adjusted to the GSM frequency, the band-pass filter 16 to the PCN frequency, and the band-pass filter 17 to the PCS frequency.

The signal inputs 2 of the GaAs switch 9 are electrically connected to transmitter amplifiers 19. The transmitter amplifiers 19, like the low-pass filters 13, 14, are adjusted to radio frequencies GSM and PCN/PCS, respectively. The signal outputs are electrically connected to receiver amplifiers 19a through the band-pass filters 15, 16, 17, wherein the receiver amplifiers 19a are adjusted to the frequency bands GSM, PCN and PCS, respectively. The antenna input 1 of the GaAs switch 9 is connected to an antenna 18. The signals received by the antenna 18 can now be fed, by means of the GaAs switch 9, into the band-pass filter 16, the band-pass filter 17 or the band-pass filter 18, where they are filtered according to the radio frequency used and further processed in amplifiers 19a. The signals supplied by the transmitter amplifiers 19 are filtered by the low-pass filters 13, 14 and optionally supplied to the antenna 18 for transmission of a signal.

FIG. 4 shows a circuit module with a multilayer ceramic substrate 20, into which passive components 21, 22, 23 are integrated. These passive components 21, 22, 23 can be resistors, capacitors 22, and inductors 23, for example. The multilayer ceramic substrate 20 can be designed in a known manner. Stacked ceramic layers 30 separated by metallic layers 31 can be used as the multilayer ceramic substrate 20. A few of the metallic layers 31 are connected to one another through continuous contacts 32 running inside the ceramic layers 30.

A switch unit 4, which, for example, can be a gallium-arsenide multiple switch assembled in flip-chip technology, is mounted on the upper side of the ceramic substrate 20.

The switch unit 4 can, for example, be secured and electrically contacted by means of gluing and additional wire-bonding. A GaAs multiple switch is preferably used as the switch unit 4. This type of switch can have an insertion loss of 0.8 dB in the frequency range between 1 and 2 GHz. It can be an integrated circuit with FET produced on a gallium-arsenide base, with its pin surfaces connected to the ceramic substrate 20 by soldering.

The switch unit 4 can also be attached to the multilayer ceramic substrate 20 and electrically bonded by means of wire bonding. Bonding by means of soldering is preferred when the switch unit 4 is to be used with an additional housing.

The passive components 21, 22, 23 can form the filters 13, 14, 15, 16, 17 required in accordance with FIG. 3.

In addition to the switch unit 4, the first protective device 6 and the second protective device 7 are also mounted onto the surface of the substrate 20. This accomplishes a high degree of integration for the circuit module according to the invention, which advantageously affects the space requirements of the circuit module.

Such a circuit module can be used in mobile telephones, for example, and it is for this reason that the advantageous use of the circuit module of the invention as a front-end module in a mobile wireless device is also the subject matter of the invention.

The invention is not limited to the examples of the second and third protective device mentioned above; instead, all conceivable protective devices can be used in the circuit array of the invention. In addition, the circuit array or the circuit module is not limited to applications in mobile telephones.

List of Reference Symbols

1 Antenna input

2 Signal input

3 Signal output

4 Switch unit

5 Control line

6, 7, 12 First, second, third protective device

8 Ground

9 Gallium-arsenide switch

10 Decoder

11 Supply line

13, 14 Low-pass filter

15, 16, 17 Band-pass filter

18 Antenna

19 Transmitter amplifier

19a Receiver amplifier

20 Multilayer ceramic substrate

21 Resistor

22 Capacitor

23 Inductor

24 Control line

30 Ceramic layers

31 Metallic layers

32 Continuous contacts

TX₁, TX₂ Transmitter inputs

RX₁, RX₂, RX₃ Receiver inputs

S₁, S₁₂, S₃, S₄, S₅ Control inputs of the switch

A₁, A₂, A₃, A₄, A₅ Control outputs of the decoder

E₁, E₂, E₃ Control inputs of the decoder

Vcc Supply voltage

1. A circuit array comprising:
an antenna input;
a signal input;
a signal output;
a switch unit that includes a control line to connect the antenna input to at least one of the signal input and the signal output;
a first protective device connected to the antenna input, the antenna input also being connected to the control line; and
a second protective device connected to the control line.

2. The circuit array of claim 1, wherein the first and second protective devices are connected to a ground.

3. The circuit array of claim 1, wherein the switch unit comprises a voltage-controlled switch.

4. The circuit array of claim 3, wherein the switch unit comprises a gallium-arsenide switch.

5. The circuit array of claim 4, further comprising:
a decoder having a supply line connected to a third protective device.

6. The circuit array of claim 1, further comprising:
frequency filters connected in series to at least one of the signal input and the signal output.

7. The circuit array of claim 1, wherein at least one of the first and second protective devices comprises a voltage-limiting element.

8. The circuit array of claim 7, wherein the voltage-limiting element comprises a varistor.

9. The circuit array of claim 7, wherein the voltage-limiting element comprises one of an electric frequency filter and a spark gap.

10. The circuit array of claim 1, wherein the second protective device comprises a varistor with a switching voltage that is less than 6 V.

11. The circuit array of claim 1, wherein the first protective device comprises an electric frequency filter with an insertion loss of less than 0.3 dB.

12. The circuit array of claim 1, wherein the antenna input is connected to an antenna, the signal input is connected to a transmission amplifier, and the signal output is connected to a reception amplifier.

13. A circuit module comprising:
a circuit array comprising:
an antenna input;
a signal input;
a signal output;
a switch unit that includes a control line to connect the antenna input the signal input and the signal output;
a first protective device; and
a second protective device
wherein the antenna input is connected to the first protective device and the control line is connected to the second protective device; and
a multilayer ceramic substrate comprised of integrated passive components that form frequency filters, the switch unit being on an upper side of the multilayer ceramic substrate, and the the first and second protective devices being integrated in the multilayer ceramic substrate.

14. The circuit module of claim 13, wherein the circuit module comprises a front-end module in a mobile telephone.

15. A circuit array comprising:
an antenna input connected to a first electrostatic discharge (ESD) protection device, and
a switch unit that includes a control line to connect to a second ESD protection device, the switch unit connecting the antenna input to one of a signal input and a signal output.

16. The circuit array of claim 15, wherein the first and second ESD protection devices are connected to a ground.

17. The circuit array of claim 15, wherein the switch unit comprises a voltage-controlled switch.

18. The circuit array of claim 15, wherein at least one of the first and second ESD protection devices includes a voltage-limiting element.

19. The circuit array of claim 15, wherein the voltage limiting element comprises a varistor.

20. The circuit array of claim 15, wherein the first ESD protection device comprises an electric frequency filter.

21. The circuit array of claim 1, wherein the first and the second protective devices protect against electrostatic discharge.

22. The circuit array of claim 13, wherein the first and the second protective devices protect against electrostatic discharge.

23. A circuit array comprising:
means for connecting an antenna input a signal input or a signal output;
means for protecting the circuit array against electrostatic discharge, the means for protecting the circuit array comprising a first protective device connected to the antenna input.
